(19) United States
(12) Patent Application Publication
(10) Pub. No.: US 2017/0194677 A1
(43) Pub. Date: Jul. 6, 2017

(54) BATTERY MODULE AND BATTERY PACK

(71) Applicant: KABUSHIKI KAISHA TOYOTA JIDOSHOKKI, Aichi-ken (JP)

(72) Inventors: Hidefumi OISHI, Kariya-shi (JP); Takayuki KATO, Kariya-shi (JP); Naoto MORISAKU, Kariya-shi (JP)

(73) Assignee: KABUSHIKI KAISHA TOYOTA JIDOSHOKKI, Aichi-ken (JP)

(21) Appl. No.: 15/315,104

(22) PCT Filed: May 18, 2015
(86) PCT No.: PCT/JP2015/064231

§ 371 Date: Nov. 30, 2016

(30) Foreign Application Priority Data
Jun. 5, 2014 (JP) 2014-116858

(51) Int. Cl. H01M 10/647; H01M 10/613; H01M 10/04; H01M 10/60; H01M 2/10

(52) U.S. Cl. CPC H01M 10/647; H01M 10/60; H01M 2/1077; H01M 10/04; H01M 2/1094; H01M 10/613

(57) ABSTRACT

A battery module is configured to be fixed to a fixed member. The battery module includes a battery body, a first end plate and a second end plate, an elastic member, and a pressing member. The battery body includes battery cells and a heat transmission plate arranged adjacent to at least one of the battery cells. The first and second end plates are arranged at two ends of the battery body. The elastic member is arranged between the first end plate and the battery body. The pressing member applies load to the first and second end plates. The heat transmission plate includes a heat absorption portion and a heat releasing portion. The heat absorption portion is arranged adjacent to the battery cell. The heat releasing portion extends from the heat absorption portion toward the second end plate and is in contact with the fixed member.

### TECHNICAL FIELD

The present invention relates to a battery module including battery cells laid out in a row and a battery pack including the battery module.

### BACKGROUND ART

A battery module generally includes battery cells laid out in a row and heat transmission plates respectively arranged adjacent to the battery cells to release heat generated from the battery cells. For example, patent document 1 describes a battery module including a group of battery cells arranged between two end plates. Heat transmission plates are each bent into an L-shaped form and arranged between adjacent ones of the group of battery cells.

### PRIOR ART DOCUMENT

### Patent Document

Patent Document 1: International Patent Publication No. 2013/145917

### SUMMARY OF THE INVENTION

### Problems that Are to be Solved by the Invention

The battery cells expand over time when used. Expansion of the battery cells applies pressure to the heat transmission plates. This may deform the heat transmission plates. Deformation of the heat transmission plates decreases the contact area between the battery cells and the heat transmission plates. This may deteriorate the efficiency for releasing heat from the battery cells.

It is an object of the present invention to provide a battery module and a battery pack that limits deterioration in the efficiency for releasing heat from the battery cells.

### Means for Solving the Problem

A battery module that solves the above problem is configured to be fixed to a fixed member. The battery module includes a battery body, a first end plate and a second end plate, an elastic member, and a pressing member. The battery body includes battery cells laid out in a row and a heat transmission plate arranged adjacent to at least one of the battery cells to release heat generated from the battery cell. The first end plate and the second end plate are arranged at two ends of the battery body in a layout direction of the battery cells to hold the battery body in between. The elastic member is arranged between the first end plate and the battery body. The elastic member is elastically deformed to absorb expansion of the battery cells. The pressing member applies load to the first and second end plates in a direction in which the first and second end plates approach each other. The heat transmission plate includes a heat absorption portion and a heat releasing portion. The heat absorption portion is arranged adjacent to the battery cell in the layout direction. The heat releasing portion extends from the heat absorption portion toward the second end plate in the layout direction and is in contact with the fixed member so that heat transmitted from the battery cell to the heat absorption portion is transmitted to the fixed member.

### BRIEF DESCRIPTION OF THE DRAWINGS

FIG. 1 is a perspective view showing one embodiment of a battery pack.

FIG. 2 is a perspective view showing end plates, a battery cell, a battery holder, and a heat transmission plate of the battery pack shown in FIG. 1.

FIG. 3 is a cross-sectional view of a battery module shown in FIG. 1.

FIG. 4 is a cross-sectional view of the battery module shown in FIG. 3 when an elastic member is elastically deformed.

FIG. 5 is a partially enlarged cross-sectional view of the battery module shown in FIG. 4.

FIG. 6A is a partially enlarged cross-sectional view showing a battery module of a comparative example.

FIG. 6B is a schematic view showing a heat transmission plate when a battery cell of the battery module of the comparative example moves.

### EMBODIMENTS OF THE INVENTION

One embodiment of a battery pack and a battery module will now be described.

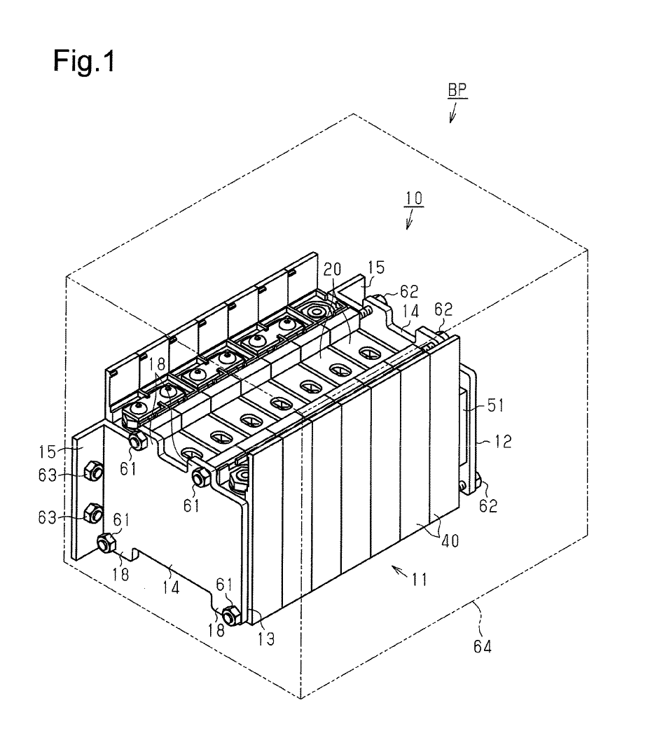

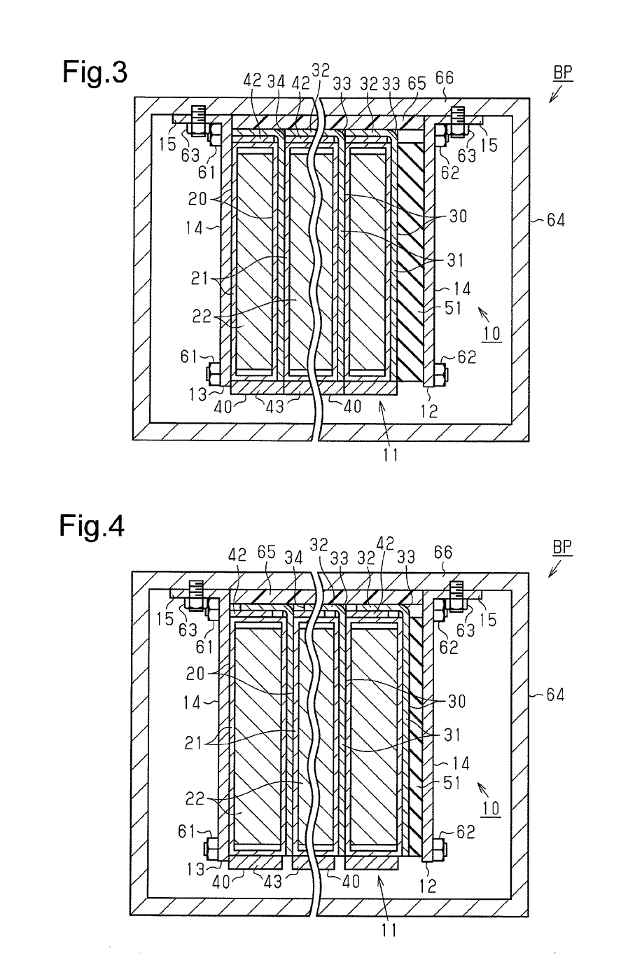

As shown in FIGS. 1 and 3, a battery pack BP includes a housing 64 functioning as a heat releasing body, and the housing 64 accommodates a battery module 10. The battery module 10 includes a battery body 11, a first end plate 12 and a second end plate 13. The first end plate 12 and the second end plate 13 hold the battery body 11 in between. The battery body 11 includes battery cells 20, which are laid out in a row, and heat transmission plates 30. The battery cells 20 and the heat transmission plates 30 are alternately arranged. Each battery cell 20 is a rechargeable battery, such as a lithium-ion battery, and is a prismatic battery. The battery cells 20 are held by separate battery holders 40, respectively.

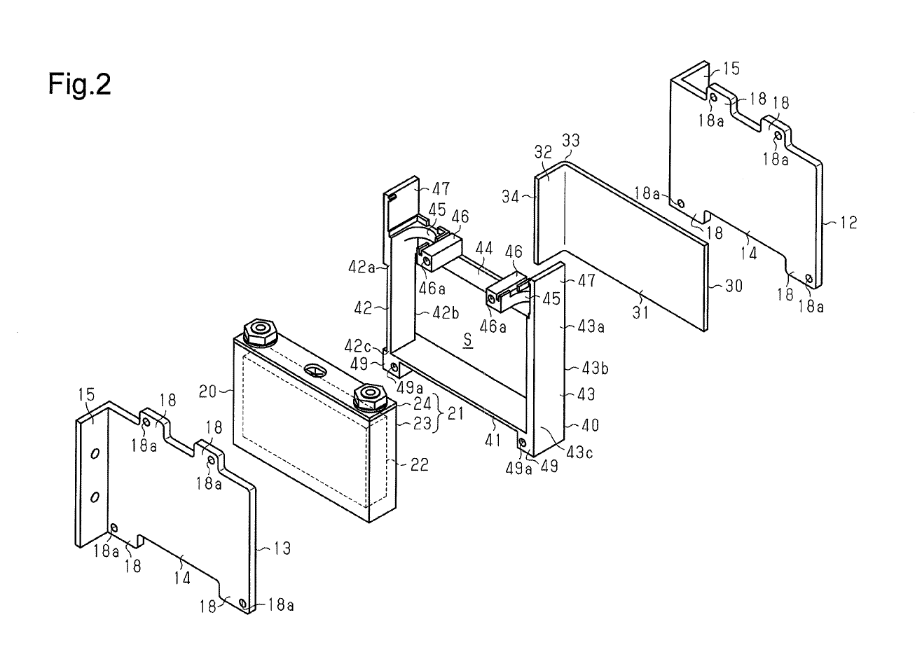

As shown in FIG. 2, each battery cell 20 includes a case 21 and an electrode assembly 22 that is accommodated in the case 21. The electrode assembly 22 includes positive electrodes and negative electrodes that are alternately arranged, and separators. Each separator is arranged between the adjacent positive and negative electrodes. The case 21 includes a box-shaped body 23, which has a closed end, and a lid 24 that closes an open end of the body 23.

Each heat transmission plate 30 is formed by bending a single metal plate into an L-shaped form. The heat transmission plate 30 includes a heat absorption portion 31, which has the form of a rectangular plate, and a heat releasing portion 32, which has the form of a rectangular plate and extends from one end of the heat absorption portion 31 in a thickness-wise direction of the heat absorption portion 31. The heat absorption portion 31 and the heat releasing portion 32 are connected at a connecting portion 33. A plate is bent to form the connecting portion 33 between the heat absorption portion 31 and the heat releasing portion 32. The connecting portion 33 is a curved portion, which is curved in an arcuate manner.

The end plates 12 and 13 are each formed by bending a plate and each include a holding portion 14 and a fixing portion 15, which have the form of plates. The holding portion 14 holds the battery body 11, and the fixing portion 15 fixes the battery module 10 to the housing 64. In the present embodiment, the holding portion 14 is rectangular, and the fixing portion 15 extends from one longitudinal end of the holding portion 14 in the thickness-wise direction of the holding portion 14. Insertion portions 18, which have the form of plates and extend in the lateral direction of the holding portion 14, are arranged on two lateral ends of the holding portion 14. The insertion portions 18 each include an insertion hole 18a extending through the corresponding insertion portion 18 in the thickness-wise direction.

Each of the battery holders 40 includes a first cover wall 41, which has the form of a rectangular plate. A second cover wall 42 and a third cover wall 43, which have the form of rectangular plates and extend in the thickness-wise direction of the first cover wall 41, are arranged on the two longitudinal ends of the first cover wall 41. The region surrounded by the first cover wall 41, the second cover wall 42, and the third cover wall 43 define an accommodation portion S that accommodates the battery cell 20. The second cover wall 42 includes a longitudinal first end 42a and a longitudinal second end 42c that is opposite to the first end 42a. The third cover wall 43 includes a longitudinal first end 43a and a longitudinal second end 43c that is opposite to the first end 43a. The first cover wall 41 is connected to the longitudinal second ends 42c and 43c of the second and third cover walls 42 and 43. A fourth cover wall 44, which has the form of a rectangular plate, is connected to the longitudinal first ends 42a and 43a of the second and third cover walls 42 and 43. The fourth cover wall 44 extends between lateral first ends 42b and 43b of the cover walls 42 and 43. The thickness-wise direction of the fourth cover wall 44 corresponds to the lateral direction of each of the cover walls 42 and 43. The second cover wall 42 and the third cover wall 43 are opposed to each other in the longitudinal direction of the fourth cover wall 44. The direction orthogonal to both the thickness-wise direction and the longitudinal direction of the fourth cover wall 44 defines the lateral direction of the fourth cover wall 44.

Terminal accommodation portions 45, which are U-shaped and open in the thickness-wise direction of the fourth cover wall 44, are arranged near the longitudinal ends of the fourth cover wall 44. The terminal accommodation portions 45 are continuous with the second cover wall 42 and the third cover wall 43, respectively.

The fourth cover wall 44 includes two insertion portions 46, which have the form of square pillars. Each of the insertion portions 46 is adjacent to the corresponding terminal accommodation portion 45. Each insertion portion 46 includes an axis extending in the lateral direction of the cover walls 42 and 43. Each insertion portion 46 includes an insertion hole 46a extending through the corresponding insertion portion 46 in the axial direction of the insertion portion 46.

Projection walls 47, which have the form of rectangular plates, extend in the longitudinal direction of the cover walls 42 and 43 from the longitudinal first end 42a of the second cover wall 42 and the longitudinal first end 43a of the third cover wall 43. Each projection wall 47 is formed integrally with the corresponding cover wall 42 or 43.

Insertion portions 49, which have the form of square pillars, are respectively arranged on the longitudinal second end 42c of the second cover wall 42 and the longitudinal second end 43c of the third cover wall 43. Each of the insertion portions 49 includes an axis extending in the lateral direction of each of the cover walls 42 and 43. Each insertion portion 49 includes an insertion hole 49a extending through the corresponding insertion portion 49 in the axial direction of the insertion portions 49.

As shown in FIG. 3, the heat absorption portion 31 of the heat transmission plate 30 is in contact with the battery cell 20. The heat releasing portion 32 of the heat transmission plate 30 covers the outer surface of the second cover wall 42 (surface opposite to accommodation portion S). The heat releasing portion 32 of the heat transmission plate 30 includes a distal end 34 that is separated from the heat absorption portion 31 (or connecting portion 33) and located toward the second end plate 13. That is, the heat releasing portion 32 extends from the heat absorption portion 31 toward the second end plate 13.

In the layout direction of the battery cells 20, the battery body 11 includes a first end corresponding to the first end plate 12 and a second end corresponding to the second end plate 13. The heat transmission plate 30 is located at the first end of the battery body 11, and the battery cell 20 is located at the second end of the battery body 11. An elastic member 51 is arranged between the first end plate 12 and the battery body 11. In the present embodiment, the heat transmission plate 30 is arranged at the first end of the battery body 11. Thus, the heat transmission plate 30 is arranged between the elastic member 51 and the battery cell 20 that is adjacent to the elastic member 51. The thickness-wise direction of the elastic member 51, which has the form of a plate, corresponds to the layout direction of the battery cells 20. Rubber or rubber sponge, for example, is used as the material of the elastic member 51.

Four bolts 61 are inserted through the battery module 10 from the second end plate 13 toward the first end plate 12. The bolts 61 are inserted through the insertion holes 18a of the second end plate 13, the insertion holes 46a and 49a of the battery holders 40, and the insertion holes 18a of the first end plate 12 and fastened to nuts 62 at the outer side of the first end plate 12. When the nuts 62 are tightened, the first end plate 12 and the second end plate 13 receive load (constraining load) in the direction in which the first end plate 12 and the second end plate 13 approach each other. The constraining load is applied to the battery cells 20 and the elastic member 51. Thus, the bolts 61 and the nuts 62 function as pressing members.

Fixing bolts 63 inserted through the fixing portions 15 of the end plates 12 and 13 are fastened to a wall 66 of the housing 64 functioning as a wall member to couple the battery module 10 to the housing 64. The battery module 10 is coupled so that the heat releasing portion 32 contacts the wall 66 of the housing 64. A heat transmission member 65 (thermal interface material, TIM) is arranged between the wall 66 of the housing 64 and the heat releasing portion 32. The wall 66 and the heat releasing portion 32 contact the heat transmission member 65. In the present embodiment, the housing 64 and the heat transmission member 65 form a fixed member. The connecting portion 33 is curved in an arcuate manner from the heat releasing portion 32 toward the heat absorption portion 31 and thus separated from the heat transmission member 65.

The operation of the battery module 10 of the present embodiment will now be described.

When the battery cell 20 is charged or discharged, the heat generated from the battery cell 20 is transmitted to the heat absorption portion 31. The heat transmitted to the heat absorption portion 31 is transmitted to the heat releasing portion 32 and then to the housing 64. In such a manner, the heat generated from the battery cell 20 is released through the heat transmission plate 30.

As shown in FIG. 4, films form on the electrodes of the battery cells 20 over time when used. This expands the battery cells 20 as the used period becomes longer. When the battery cells 20 expand, adjacent ones of the battery cells 20 push each other with the heat transmission plate 30. Forces act on each battery cell 20 toward the two layout direction ends. The forces elastically deform and contract the elastic member 51 in the thickness-wise direction (layout direction of battery cells 20). Thus, the elastic deformation of the elastic member 51 absorbs the expansion of the battery cells 20.

The elastic member 51 is arranged between the first end plate 12 and the battery body 11, and the elastic member 51 is not arranged between the second end plate 13 and the battery body 11. Thus, when the elastic member 51 is elastically deformed, the battery cells 20 and the heat transmission plates 30 move toward the first end plate 12 (elastic member 51).

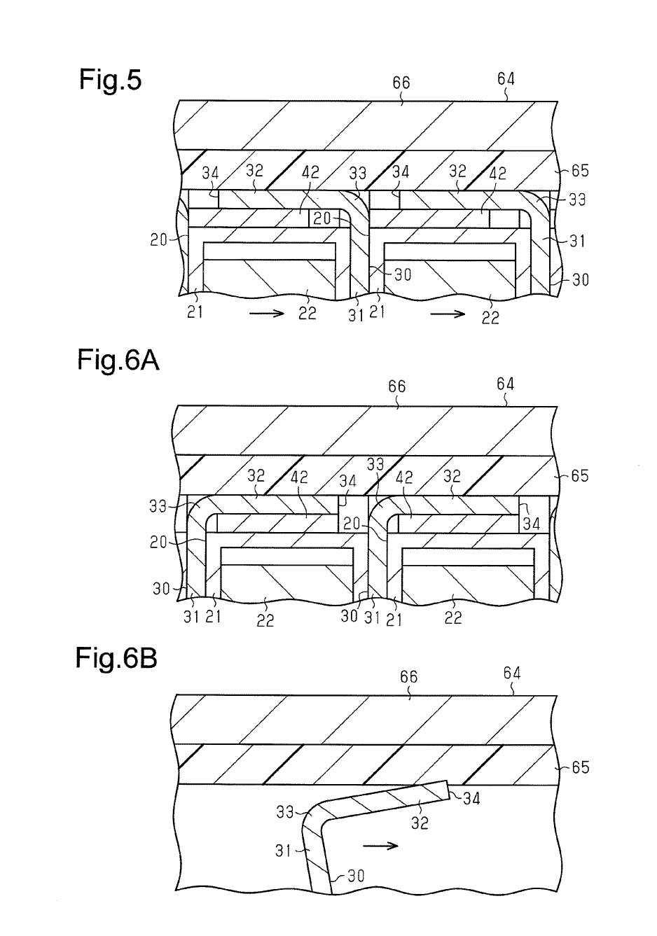

As shown in FIG. 5, when the heat transmission plate 30 moves, the distal end 34 of the heat releasing portion 32 is not directed in the movement direction. This limits situations in which the distal end 34 of the heat releasing portion 32 is caught in the heat transmission member 65. Further, the connecting portion 33 is separated from the heat transmission member 65. This limits situations in which the connecting portion 33 is caught in the heat transmission member 65. Further, the concentration of the load from the battery cell 20 at the heat absorption portion 31 is limited.

As shown in FIG. 6A, when the distal end 34 of the heat releasing portion 32 is directed in the movement direction of the heat transmission plate 30, the distal end 34 of the heat releasing portion 32 is apt to being caught in the heat transmission member 65 when the heat transmission plate 30 moves. This may damage the heat transmission member 65 and inhibit transmission of heat from the heat releasing portion 32 to the housing 64.

As shown in FIG. 6B, when the distal end 34 of the heat transmission plate 30 is caught in the heat transmission member 65, that is, when movement of the heat transmission plate 30 is restricted, load is applied from the battery cell 20 to the heat transmission plate 30. In this case, the load from the battery cell 20 concentrates at the heat absorption portion 31. Thus, the heat absorption portion 31 is bent from the connecting portion 33 of the heat transmission plate 30. The drawing is illustrated in an exaggerated manner to assist understanding. Actually, the heat absorption portion 31 is adjacent to the battery cell 20, and the battery cell 20 limits bending of the heat absorption portion 31. Thus, the heat absorption portion 31 is only slightly bent. However, the slight bending reduces the contact area between the battery cell 20 and the heat absorption portion 31 and reduces contact between the battery cell 20 and the heat absorption portion 31. This interferes with the transmission of the heat generated from the battery cell 20 to the heat absorption portion 31.

Accordingly, the present embodiment has the advantages described below.

(1) The heat releasing portion 32 of the heat transmission plate 30 extends from the heat absorption portion 31 toward the second end plate 13. Thus, the distal end 34 of the heat releasing portion 32 is directed toward the second end plate 13. In other words, the distal end 34 of the heat releasing portion 32 is directed toward the side opposite to the elastic member 51. The elastic member 51 is arranged between the first end plate 12 and the battery body 11. Thus, when the battery cell 20 expands, the heat transmission plate 30 moves toward the first end plate 12, that is, the heat transmission plate 30 moves toward the elastic member 51. Accordingly, when the heat transmission plate 30 moves, the distal end 34 of the heat releasing portion 32 is not easily caught in the heat transmission member 65 since the distal end 34 of the heat releasing portion 32 is not directed in the movement direction of the heat transmission plate 30. This limits the concentration of load from the battery cell 20 at the heat absorption portion 31 that would occur when the distal end 34 of the heat releasing portion 32 is caught. This also limits deformation of the heat absorption portion 31 of the heat transmission plate 30. Thus, decreases in the contact area between the battery cell 20 and the heat absorption portion 31 are limited. As a result, deterioration in, the efficiency for releasing heat from the battery cell 20 is limited.

(2) The heat absorption portion 31 and the heat releasing portion 32 are connected by the connecting portion 33. The connecting portion 33 is not in contact with the heat transmission member 65. This limits situations in which the connecting portion 33 is caught in the heat transmission member 65 when the heat transmission plate 30 moves. Thus, deterioration in the efficiency for releasing heat from the battery cell 20 is limited.

(3) The heat transmission member 65 is arranged between the heat releasing portion 32 and the housing 64. Thus, the heat transmitted from the battery cell 20 to the heat releasing portion 32 is easily transmitted to the housing 64.

(4) The heat transmission plate 30 is arranged between the elastic member 51 and the battery cell 20 that is adjacent to the elastic member 51. The elastic member 51 has a smaller thermal conductivity than the heat transmission plate 30. When the elastic member 51 is in contact with the battery cell 20, the transmission of the heat generated by the battery cell 20 to the elastic member 51 is limited. When the heat transmission plate 30 is arranged between the elastic member 51 and the battery cell 20, the heat generated from the battery cell 20 is transmitted to the heat transmission plate 30. This limits deterioration in the efficiency for releasing heat from the battery cell 20.

The embodiment may be modified as described below.

The heat absorption portion 31 and the heat releasing portion 32 may be connected to each other without the curved connecting portion 33. For example, the heat absorption portion 31 and the heat releasing portion 32, which have the form of plates, may be welded to directly connect the heat absorption portion 31 and the heat releasing portion 32.

The heat releasing portion 32 may be in direct contact with the housing 64. That is, the heat transmission member 65 may be omitted.

The heat transmission plate 30 does not have to be arranged between the elastic member 51 and the battery cell 20 that is adjacent to the elastic member 51. That is, the elastic member 51 may be in direct contact with the battery cell 20.

The heat transmission plates 30 and the battery cells 20 do not have to be alternately arranged. For example, a heat transmission plate 30 may be arranged for every multiple number of battery cells.

The number of the heat transmission plates 30 may be one.

The heat absorption portion 31 and the heat releasing portion 32 of the heat transmission plate 30 only need to have the form of a plate. The heat absorption portion 31 and the heat releasing portion 32 may be circular or polygonal.

The pressing member may be a metal band extended from the first end plate 12 to the second end plate 13 and fixed to each of the end plates 12 and 13.

The wall member may be a counterweight installed in an industrial vehicle.

1. A battery module configured to be fixed to a fixed member, the battery module comprising:
a battery body including battery cells laid out in a row and a heat transmission plate arranged adjacent to at least one of the battery cells to release heat generated from the battery cell;
a first end plate and a second end plate arranged at two ends of the battery body in a layout direction of the battery cells to hold the battery body in between;
an elastic member arranged between the first end plate and the battery body, wherein the elastic member is elastically deformed to absorb expansion of the battery cells; and
a pressing member that applies load to the first and second end plates in a direction in which the first and second end plates approach each other, wherein
the heat transmission plate includes a heat absorption portion and a heat releasing portion, wherein the heat absorption portion is arranged adjacent to the battery cell in the layout direction, and the heat releasing portion extends from the heat absorption portion toward the second end plate in the layout direction and is in contact with the fixed member so that heat transmitted from the battery cell to the heat absorption portion is transmitted to the fixed member.

2. The battery module according to claim 1, wherein the heat transmission plate includes a connecting portion that connects the heat absorption portion and the heat releasing portion, and
the connecting portion is curved and separated from the fixed member.

3. The battery module according to claim 1, wherein the heat transmission plate is arranged between the elastic member and the battery cell that is adjacent to the elastic member.

4. A battery pack comprising:
the battery module according to claim 1; and
the fixed member to which the battery module is fixed, wherein the fixed member includes a wall member to which the battery module is coupled and a heat transmission member arranged between the wall member and the heat releasing portion.
